(19) United States
(12) Patent Application Publication
(10) Pub. No.: US 2025/0138815 A1
(43) Pub. Date: May 1, 2025

(54) AUTOMATIC HEALING OF MICROSERVICE DEPENDENCY INCOMPATIBILITY

(71) Applicant: International Business Machines Corporation, Armonk, NY (US)

(72) Inventors: Keith Donald Cramer, Pine Island, MN (US); Ramkumar Gowrishankar, Apex, NC (US); JIAWEI WEN, Cedar Park, TX (US); Priya Ajay Ingle, Austin, TX (US)

(21) Appl. No.: 18/497,017

(22) Filed: Oct. 30, 2023

(51) Int. Cl. G06F 8/71; G06F 8/65

(52) U.S. Cl. CPC G06F 8/71; G06F 8/65

(57) ABSTRACT

A system may include a memory and a processor in communication with the memory. The processor may be configured to perform operations. The operations may include determining an application programming interface (API) version dependency between a first microservice and a second microservice; the first microservice and the second microservice are in a set of dependent microservices. The method may include detecting an incompatible API version in the set of dependent microservices, automatically requesting a version change for the incompatible programming interface version, and implementing the version change.

### BACKGROUND

The present disclosure relates to computing dependencies and compatibilities and more specifically to dependencies and incompatibilities in microservice systems.

Cloud computing is a model of service delivery for enabling convenient, on-demand network access to a shared pool of configurable computing resources that may be rapidly provisioned and released with low management effort or interaction with a provider of the service. Services may be provided via one or more service providers with dependencies on one or more other service providers. In microservice systems, individual services may call other services to complete tasks. These services must be compatible with each other; if a service calls a function in another service that is incompatible, the system function may fail because the called service cannot perform its required function.

### SUMMARY

Embodiments of the present disclosure include a system, method, and computer program product for healing of microservice dependency incompatibility. A system in accordance with the present disclosure may include a memory and a processor in communication with the memory. The processor may be configured to perform operations. The operations may include determining an application programming interface (API) version dependency between a first microservice and a second microservice; the first microservice and the second microservice are in a set of dependent microservices. The operations may include detecting an incompatible API version in the set of dependent microservices, automatically requesting a version change for the incompatible programming interface version, and implementing the version change.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates the architecture of a system in accordance with some embodiments of the present disclosure.

FIG. 2 depicts the architecture of a system in accordance with some embodiments of the present disclosure.

FIG. 3 illustrates a flowchart for resolving microservice incompatibility in accordance with some embodiments of the present disclosure.

FIG. 4 depicts a flowchart for resolving microservice incompatibility in accordance with some embodiments of the present disclosure.

FIG. 5 illustrates a computer-implemented method for resolving microservice incompatibility in accordance with some embodiments of the present disclosure.

FIG. 6 depicts a computer-implemented method for resolving microservice incompatibility in accordance with some embodiments of the present disclosure.

FIG. 7 depicts a block diagram illustrating an embodiment of a computer system, and the components thereof, upon which embodiments described herein may be implemented in accordance with the present disclosure.

FIG. 8 depicts a block diagram illustrating an extension of the computing system environment of FIG. 7 wherein the computer systems are configured to operate in a network environment (including a cloud environment) and perform methods described herein in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computing dependencies and compatibilities and more specifically to dependencies and incompatibilities in microservice systems.

A microservice architected system may utilize a clustering mechanism such as an open-source cluster of hosts. Hosts may include, for example, pods. Services in a microservice architected system may have dependencies on other microservices for one or more versions when one service calls another. When a new service is deployed, services called need to be compatible. If a compatible service version is not available, the system function will fail because it cannot call a service with a compatible version. Release management software and administrators may try to keep deployed service versions at compatible levels, but errors may occur. If an incompatible service is deployed, system changes may be used to detect and correct the incompatibility; in some circumstances, compatibility issues may be corrected by deploying compatible services.

Some embodiments of the present disclosure may detect application programming interface (API) version incompatibility in dependent services. In some embodiments, detection of incompatible versions of APIs in dependent services may be enabled (e.g., for a system using the invention and/or a system in communication with a device using the invention).

A modified service may require multiple deployments of other services to be updated (e.g., upgraded and/or downgraded) such that the version of the service is changed. These modifications (e.g., upgrades, downgrades, and/or other version changes) may also require one or more service deployment cascades. Some embodiments of the present disclosure may identify API compatibility adjustment requirements including any necessary service deployment cascades.

An incompatibility (e.g., an API version incompatibility) may require a version change. A version change may be an update or other modification to a version used by a microservice. A version change may be a change from a version of a service (e.g., a program) currently in use by a microservice to an alternative version of the service. In some circumstances, a version change may be an upgrade to a more recent version; an example of an upgrade is a microservice using version 1.112 of a program, version 1.113 of the program was more recently released, and the microservice removes version 1.112 to instead install version 1.113. In some circumstances, a version change may be a downgrade to a less recent version; an example of a downgrade is a microservice may be using version 1.112 of a program, a workload may require version 1.111 of the program, and the microservice may remove version 1.112 to instead install version 1.111 to execute the workload.

A microservice may have one version of a service (e.g., a program) installed but may have need of an alternative version of the service. An alternative version may be any version not currently installed by a microservice; an alternative version may be a more recent or previous version of the same program. For example, a microservice may have version 1.112 of a program installed, and the execution of a certain workload may require the more recent (e.g., an upgrade) version 1.113 of the program; in this example, the more recent version 1.113 is the alternative version. In another example, a microservice may have version 1.112 installed, and the execution of a requested workload requires the original official release (e.g., a downgrade) of the program, version 1.001; in this example, the original version 1.001 is the alternative version.

In some embodiments of the present disclosure, a microservice (e.g., pod) version update may be automated or may require user (e.g., operator or administrator) approval. A version update (e.g., an upgrade or a downgrade) may be automatically deployed if automatic implementation of the version change is permitted according to system settings and/or protocol. Similarly, a version update may require operator approval based on system settings and/or protocol. In some embodiments, certain version changes may require user approval (e.g., a beta testing version) whereas others may not (e.g., a known version from a trusted source).

Some embodiments of the present disclosure may enable the prevention of service pod deployment if any dependent services are not compatible. In some embodiments of the present disclosure, incompatible deployment concerns may be detected and reported (e.g., to a user).

An open-source container system may include one or more clusters with nodes, pods, and containers. Some containers in the system may be init containers. Init containers may perform one or more tasks before a microservice (e.g., a pod or a program) is started. Init containers may aggregate any necessary API versions, perform version checks on available API versions, and request a microservice (e.g., a pod) upgrade if such an upgrade is necessary.

In accordance with the present disclosure, an open-source container system may include a deployment manager. A deployment manager may assist in the generation, description, and/or alteration (e.g., reassignment or update) of resources in a cluster. An init container may request a deployment manager to update a microservice or program to a different version. The deployment manager may process the request, determine whether automatic update is enabled, and deploy an updated (e.g., upgraded and/or downgraded) version of the microservice or program.

In some embodiments, the deployment manager may request the approval of a user such as an administrator. Approval may be sought, for example, if an init container determines that a microservice upgrade is necessary but automatic version changes are not enabled. In some embodiments, approval may be sought because system settings require approval before updates (e.g., upgrades or downgrades), implementation of any changes, or the like. The system settings may require approval before any changes are made or only before certain changes are made; these settings may be default settings or may be selected by a user such as an administrator.

In some embodiments, the deployment manager may submit an incompatibility report to a user. For example, the deployment manager may notify the user that a deployment request has been received by a service but that the request is incompatible with the microservices available. In some embodiments, the incompatibility report may be submitted to the user with or as part of a request for approval to update (e.g., upgrade or downgrade) or otherwise make a change within the system. In some embodiments, the incompatibility report may be submitted to the user separate from an approval request; for example, automatic upgrades may be enabled such that no approval is necessary for an upgrade.

In some embodiments of the present disclosure, one or more version config data structure may be used. An example of a version config data structure in accordance with the present disclosure is:

PodDeploymentRequest {

Spec:

| | |
|---|---|
| “Name” | :“MicroServiceB” |
| “URL” | :“https:/a.b.c/regional-extension-server/getVersion” |

| | |
|---|---|
| “CurrentVersion” | : “1.112” |

| | |
|---|---|
| “RequestorList” | : { “RequestItem1, RequestItem2”} |

Status:

| | |
|---|---|
| “DeploymentStatus” | : “(waiting for operator |

approval/in-progress/scheduled/complete/canceled/error)”

| | |
|---|---|
| “DeployedVersion” | : 1.113 |
| } | |
| RequestItem1: { | |

```
    “RequestedVersion” : RequestedVersion1
    “Requestor” : “MicroServiceA”
    “RequestorVersion” : “2.21”
```

}

```
          RequestItem2: {
    “RequestedVersion” : RequestedVersion2
    “Requestor” : “ MicroServiceC”
    “RequestorVersion” : “7.8”
```

}
}

In some embodiments of the present disclosure, an init container version spec may be used to store the information regarding versions requested by different services in the deployment manager. An init container version spec may be used to identify a version range (e.g., a specific version, a minimum version, and/or a maximum version) for a service to execute a workload. An example of an init container version spec in accordance with the present disclosure is:

```
// requested by MicroServiceA
RequestedVersion1: {
  “MinimumVersion” : “1.113”
  “MaximumVersion” : “1.113”
}
// requested by MicroServiceC
RequestedVersion2: {
  “MinimumVersion” : “1.113”
  “MaximumVersion” : “1.114”
}
// requested by MicroServiceA
RequestedVersion1: {
  “MinimumVersion” : “1.113”
  “MaximumVersion” : “1.113”
}
// requested by MicroServiceC
RequestedVersion2: {
  “MinimumVersion” : “1.113”
  “MaximumVersion” : “1.114”
}
```

In this example, the net effect is that version 1.113 will be deployed.

In some embodiments of the present disclosure, a data structure such as an init container version spec may be used to identify requested versions and/or acceptable version ranges. For example, if any version is compatible, an init container version spec may be:

```
# Any Version allowed
RequestedVersion0: {
  “MinimumVersion” : “”
  “MaximumVersion” : “”
}
```

Similarly, if a specific version of a service, microservice, or API is requested to execute a workload, the init container spec may identify this constraint. An example of an init container version spec requiring version 1.1113 is:

```
# Specific Version Required Example
RequestedVersion1: {
  “MinimumVersion” : “1.113”
  “MaximumVersion” : “1.113”
}
```

Moreover, if a version minimum (e.g., a version released on or after a certain date) is necessary, the init container spec may identify this constraint. An example of an init container version spec requiring version 1.1113 or later is:

```
# Minimum Version or greater
RequestedVersion2: {
  “MinimumVersion” : “1.113”
  “MaximumVersion” : “”
}
```

Likewise, a version maximum (e.g., a version released on or before a certain date) is necessary may also be identified by the init container version spec. An example of an init container version spec requiring version 1.1114 or earlier is:

```
# Maximum Version or less
RequestedVersion3: {
  “MinimumVersion” : “”
  “MaximumVersion” : “1.114”
}
```

Correspondingly, the init container version spec may also indicate an acceptable range of versions to execute a workload. A range may be continuously consecutive (e.g., any integer between one and ten) or may skip one or more versions (e.g., any integer between one and ten except for integers five and seven). An example of an init container version spec requiring a version between version 1.113 and version 1.114, inclusive, is:

```
# Acceptable Range:
RequestedVersion4: {
  “MinimumVersion” : “1.113”
  “MaximumVersion” : “1.114”
}
```

In some circumstances, init container version specs may express an incompatible version request. An incompatible version request may, for example, include contradicting requirements. For example, in a system with two interdependent microservices, one microservice may require an original version (e.g., version 1.001) whereas the other microservice requires the most recent version (e.g., version 1.114). An example of an incompatible version request is:

### Pod 1: Minimum Version: 1.114

### Pod 2: Maximum Version: 1.113

A user (e.g., an operator, an administrator, developer, or person requesting a service) may resolve an incompatible version request. For example, a person requesting a service may request an alternative, or an administrator may manually deploy a different version on both pods that solves incompatibility issues (e.g., newly released version 1.117 which may have been specifically developed to resolve a known incompatibility issue between the requested versions).

The present disclosure includes discussion of the augmentation (such as improvement of) existing release management solutions. For example, the present disclosure includes discussion regarding the detection and/or correction of deployment errors. Moreover, the present disclosure discusses the detection and/or correction of incompatible pods; whereas manual intervention would typically be required, the present disclosure enables automating incompatibility detection and/or correction.

Additionally, the present disclosure enables automatically updating (e.g., upgrading and/or downgrading) microservices (e.g., pods), including support for required deployment cascades throughout the impacted system. In some circumstances, an update may trigger a cascade of deployments. In some embodiments, the present disclosure enables automation of deployment cascades; events that might otherwise have necessitated a manual collection of deployments may be addressed with one or more automatic system responses.

A system may include a memory and a processor in communication with the memory. The processor may be configured to perform operations. The operations may include determining an application programming interface (API) version dependency between a first microservice and a second microservice; the first microservice and the second microservice are in a set of dependent microservices. The operations may include detecting an incompatible API version in the set of dependent microservices, automatically requesting a version change for the incompatible programming interface version, and implementing the version change.

In some embodiments, the version change may be selected from the group consisting of an upgrade or a downgrade. An upgrade may be considered changing to a newer version (e.g., a more recent version which may or may not be the most current version); for example, it would be an upgrade to change from version 1.113 to the more recently released version 1.114. A downgrade may be considered changing to an older version (e.g., a less recent version than the microservice is currently using); for example, it would be a downgrade to change from version 1.113 to the less recently released version 1.112.

In some embodiments, the operations may include deploying an updated microservice in the set of dependent microservices. In some embodiments, deploying an updated microservice may enable the set of dependent microservices to complete currently-running tasks while addressing the needs of new incoming tasks. In some circumstances, an update to a program may interfere with current workloads, and deploying a new microservice may enable current workload completion; for example, a pod may be executing a workload requiring a previous version of a program (e.g., version 1.112) and a new task may require the most updated version of the same program (e.g., version 1.115), and deploying the updated microservice may enable the cluster to complete the current task while also providing for the execution of the new task. In some circumstances, a system may identify a likelihood of requiring the non-updated microservice after a newly requested workload; for example, a user may decide to test executing a workload with a new version (e.g., run a beta test) of a program to identify problems to address before releasing the new version, and the system may deploy a separate pod for executing the workload while executing other tasks with the same program in other pods.

In some embodiments, the version change may be implemented automatically. Implementing updates automatically may alleviate time constraints (e.g., the workload will not need to wait until the update is manually approved for the microservice to execute it). Automatic implementation may work best in an environment where the source of the version to be implemented is trusted (e.g., an intranet repository), there is a history of regular updates for the program, and/or the change in the version is within predetermined parameters.

In some embodiments, the version change may be implemented upon approval of an administrator. Requiring administrator approval for a version change engages more manual control and permits for more checks over the system; additional control may be preferred in certain environments (e.g., clusters with sensitive workloads and/or information), for certain programs (e.g., for programs with a history of glitch-ridden updates), for training personnel (e.g., an experienced administrator showing a new administrator an approval process), for other training purposes (e.g., a supervised learning approach of a machine learning algorithm), and the like. Administrator approval of a version change may be preferred in situations in which a version to be implemented would not be retrieved from a trusted source (e.g., from an unvetted or previously unused source), it is unusual for the program to require updates (e.g., the program has not offered an update in several years), the version change is outside of defined version change parameters (e.g., the size of the version requested is substantially different that of other versions), the version change request itself prompts a flag from the system (e.g., the request is unusual), or the like.

In some embodiments, the operations may include delaying a microservice deployment until the version change is complete. Delaying microservice deployment may enable the system to avoid version incompatibility issues, scheduling conflicts, or other potential concerns. In some embodiments, delaying the microservice deployment may be responsive to the incompatible API version in the set of dependent microservices. In some embodiments, delaying the microservice deployment may be preventing the microservice deployment.

In some embodiments, the operations may include reporting the incompatible API version to a user. Reporting the incompatibility to the user may enable the user to respond to the incompatibility concern. For example, the user may identify that the incompatibility is likely to impact other interdependent microservice systems and may proactively prepare the other systems for a required version change. In some circumstances, the user may respond by determining a preferred mechanism for handling the incompatibility (e.g., enabling an automatic version change for the issue and/or an automatic change back to the previous version after the completion of the workload). In some embodiments, reporting the incompatible API version to the user may be responsive to the requested microservice version update for the incompatible API version being unavailable; for example, a requested microservice version may not be in any available library or repository as it may have been previously deleted or not yet obtained. In some embodiments, the user may be a system administrator, operator, and/or developer. In some embodiments, the user may be the entity requesting the workload requiring a version change.

In some embodiments, the operations may include retrieving a version for the version change from a repository. The version may be, for example, stored as an image in a library in the repository. A repository may store one or more versions; a repository may store many versions of programs and/or microservices (e.g., many microservice API versions). The version retrieved from the repository may be any of the versions stored; for example, one workload may result in a request to upgrade a microservice API version from 1.113 to 1.115, and a later workload may result in a request to downgrade the microservice API version from 1.115 to 1.111. In some embodiments, any version stored in the repository may be retrieved, regardless as to whether the request is for an upgraded version, a downgraded version, or another version (e.g., a downgraded version modified with a feature from a more recent version).

Some repositories may undergo pruning such that some images may no longer be available in the repository. In some circumstances, the pruned images may no longer be available for retrieval, or the images may be available for retrieval via an external source (e.g., via the internet, intranet, or some other a connection to another repository).

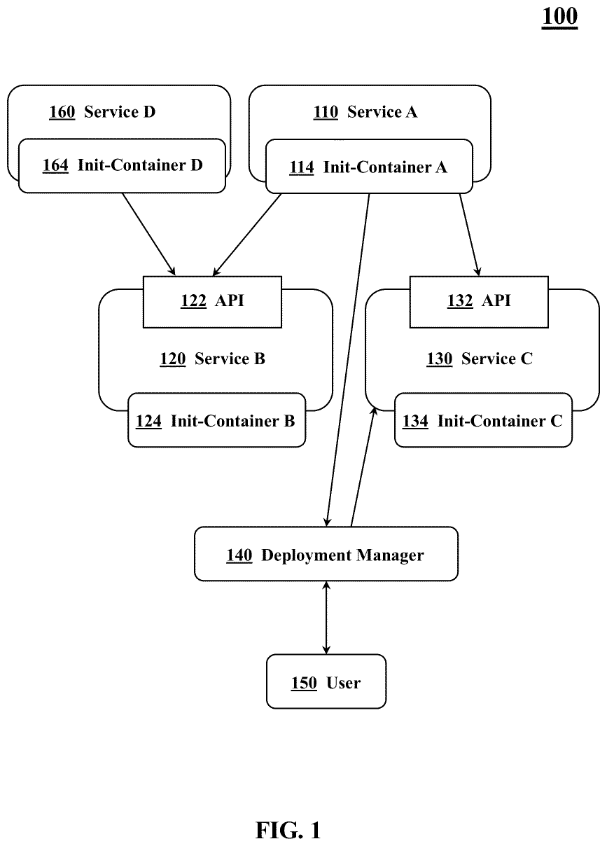

FIG. 1 illustrates the architecture of a system 100 in accordance with some embodiments of the present disclosure. The system 100 includes various services; a user 150 may interact with the system 100 via a deployment manager 140.

The system 100 includes service A 110. Service A 110 may call one or more other services to perform a required task; for example, service A 110 may call service B 120 and service C 130 to process sub-functions required for a task. For example, in some embodiments, service A 110 may be, act as, or otherwise perform the functions of a control plane service and/or control node. A control plane may be a container orchestration layer; a control plane may manage an open-container system or its components by, for example, defining, deploying, and/or managing containers and/or the lifecycle thereof.

Service A 110 may include init-container A 114. Init-container A 114 may aggregate API versions (e.g., which API versions are currently in use and which API versions are necessary for compatibility between services and/or for programs). Init-container A 114 may perform version check(s) on available API versions. The system 100 may detect one or more incompatible versions between interdependent services within the system and identify a need and/or opportunity to change one or more versions to improve interdependent service compatibility. In some embodiments of the present disclosure, init-container A 114 may identify a necessary version change for a requested workload; in some embodiments, init-container A 114 may identify a future or likely future version change request (e.g., a cascade which will be requesting a different version, or an update in a different part of the system that will likely impact other parts of the system).

An init-container such as init-container A 114 may aggregate any necessary API versions, perform one or more versions checks on available API versions, and request a microservice (e.g., a pod) update if such an update is necessary. In some embodiments of the present disclosure, init-container A 114 may identify an incompatible version and/or request a version change for a microservice (e.g., a pod). Init-container A 114 may request a microservice version change from the deployment manager 140 in the system 100.

Init-container A 114 may request the deployment manager 140 update a microservice to a different version. The deployment manager 140 may process the request, determine whether automatic update is enabled, and deploy the new, updated version of the microservice.

In some embodiments, the deployment manager 140 may request the approval of a user 150 such as an administrator. Approval may be sought, for example, if init-container A 114 determines that an upgrade is necessary but the deployment manager 140 determines that the automatic version upgrade is not enabled. In some embodiments, approval may be sought because system settings require approval before certain updates (e.g., version changes of certain programs), implementation of any changes, or the like. The system settings may require approval before any changes are made or only before certain changes are made; the system settings may be default settings or may be selected by a user 150 (e.g., an administrator).

In some embodiments, the deployment manager 140 may submit an incompatibility report to a user 150. For example, the deployment manager 140 may notify the user 150 that a deployment request has been received by service A 110 but that the request is incompatible with the microservices versions available. Another example of incompatibilities is if service A 110 needs a specific version of service B 120 and service D 160 also calls on service B 120 requiring a different version; this is also an incompatibility because only one version of service B 120 can be deployed at a time. Service D 160 may use init-container D 164 to communicate with other services. In some embodiments, the incompatibility report may be submitted to the user 150 with or as part of a request for approval to update a version or otherwise make a change within the system 100. In some embodiments, the incompatibility report may be submitted to the user 150 separate from an approval request; for example, automatic updates may be enabled such that no approval is necessary for an upgrade, and an incompatibility report may be submitted to the user 150 to notify the user 150 that an update was automatically executed.

The system 100 may receive a request to process a workload; the system 110 may task service A 110 with assigning the workload to the proper resources. Service A 110 may contact service B 120 to determine whether service B 120 has the resources to execute the workload. Service B 120 may have an API 122 and an init-container B 124. Service A 110 may contact service B 120 by communicating with the API 122 for service B 120 to determine whether service B 120 has the necessary resources for executing the workload.

Service A 110 may contact service C 130 to determine whether service C 130 has the resources to execute a workload. Service C 130 may have an API 132 and an init-container C 134. Service A 110 may contact service C 130 to determine service C 130 resource availability.

As shown in FIG. 1, in accordance with the present disclosure, service A 100 may determine that service C 130 is capable of executing a requested workload but requires a version change to execute the workload. Init-container A 114 may thus communicate to the deployment manager 140 that a microservice (e.g., service C 130) requires an alternative version (e.g., an upgrade or a downgrade) to execute a workload.

The deployment manager 140 may process the request for the version change. In some embodiments, the deployment manager 140 may determine whether an automatic version change (e.g., update such as an upgrade or a downgrade) is enabled. In some embodiments, the deployment manager 140 may determine that the requested version change is approved for automatic implementation (e.g., by default or by a manually selected setting); if automatic implementation of the requested version change is approved, then the deployment manager 140 may implement a version change. In some embodiments, the deployment manager 140 may determine that the requested version change is not approved for automatic implementation and request permission for implementation from a user 150 (e.g., an administrator and/or developer); the deployment manager 140 may wait for approval of the request for implementation to implement the version change.

In some circumstances, the user 150 may deny a version change (e.g., an administrator identified an issue with the version requested) and the deployment manager 140 would not implement the requested version change. The user 150 may deny a version change for a variety of reasons; for example, a requested version may have no licenses available (e.g., three of three licenses are already in use), be unavailable (e.g., not available for download from an approved source), or have previously caused an issue in the system (e.g., demanded more resources than it was allocated). If a requested version change is not implemented, the deployment manager 140 may, for example, notify a user 150 (e.g., operator and/or resource requestor) of request details (e.g., the workload with need of the requested version, the microservice selected to execute the workload, the current version of the service identified as needing an alternative version, other potential alternative version options, the requester of the workload, the expected resources required by the workload, and the like). The user 150 may use the information, for example, to identify an appropriate alternative version (e.g., version 1.113 is requested and denied but version 1.114 would be able to execute the workload and is available for implementation) or resource (e.g., an alternative host) for the workload.

The deployment manager 140 may implement a version change upon the determination that automatic updates are enabled or upon the approval of the user 150. The deployment manager 140 may communicate with the selected service in the system to deploy an updated version. As the system 100 identified service C 130 as the host for the requested workload, the deployment manager 140 may communicate with service C 130 to deploy the updated version. The updated version may be, for example, the requested version or an alternative version identified as capable of executing the requested workload. The updated version may be, for example, an upgrade (e.g., a newer version) or a downgrade (e.g., an older version).

In some embodiments of the present disclosure, service A 110 may determine that the presently-available services are unable to process a requested workload. For example, the system 100 may only have services A and B, and service A 110 may determine that service B 120 does not have the resources available necessary to execute the workload. Service A 110 may request the deployment manager 140 deploy a new version of the service. The deployment manager 140 may receive the necessary approvals (if any) for deployment and/or version implementation and may deploy a new version of service C 130

A workload may request and/or require an alternative version of a service for execution. An alternative version of the service may be, for example, downloaded from an external source such as the internet (e.g., the website of the company offering the program) or received from a local source (e.g., via intranet connection, external hard drive, or another repository). In some embodiments, an alternative version of the service may be retrieved from a repository. A repository may store current and/or previous versions of a program. One or more versions of one or more programs may be stored in a repository. Each program may, for example, have a library of versions such that each version is stored as an image in the program library. A library may contain multiple versions of a program such that multiple versions are available for retrieval by connected microservices.

Connected microservices may request any of the available versions in the library of the repository. A microservice may request a version not available in the repository. For example, a workload may require a new version of a program that the repository has not yet obtained and thus does not yet have available. Upon receiving a request for a certain version that is not available, the repository may obtain the version (e.g., request administrator permission to download the version from the website, obtain it from another repository, or automatically download the version) and the deployment manager may then retrieve the version from the repository. In some embodiments of the present disclosure, the microservice may not start and may wait for (e.g., block) the deployment manager from deploying a compatible version of a service; the previous version of the blocked service may continue to run until the new version is deployed.

A library may contain all of the versions of a program or may be pruned to contain only necessary versions. For example, a user may determine that pruning will facilitate objectives (e.g., free up space for other projects) and may remove certain versions from the repository (e.g., versions that have not been required within the last year). If a version is removed from the repository and later requested by a microservice, the version will not be available in the repository; the version may be obtained such as by re-acquisition by the repository (e.g., obtaining it from another repository or downloading it from an external source) or by the microservice retrieving the version from another source (e.g., direct download).

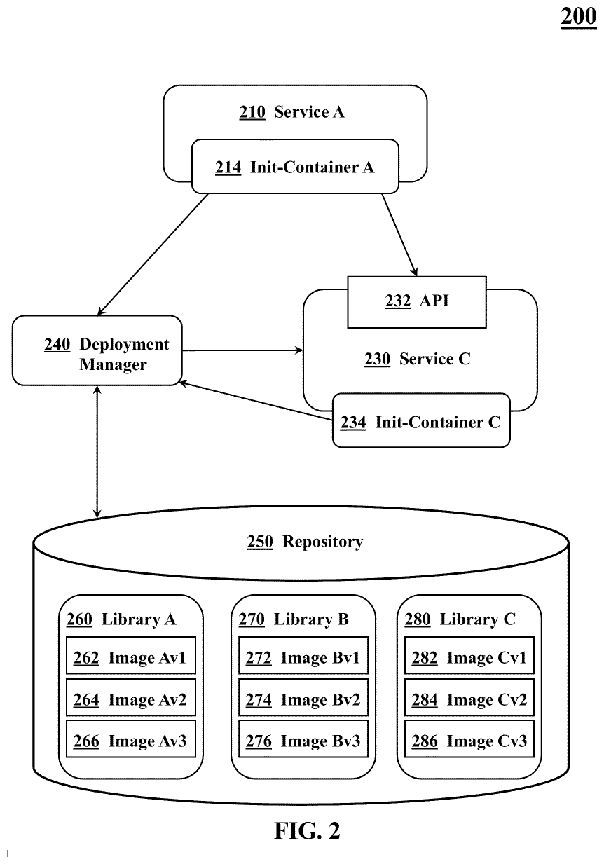

FIG. 2 depicts the architecture of a system 200 in accordance with some embodiments of the present disclosure. The system 200 includes service A 210, service C 230, a deployment manager 240, and a repository 250.

Service A 210 may include init-container A 214. Init-container A 214 may aggregate API versions (e.g., which API versions are currently in use and which API versions are necessary for compatibility between services and/or for programs) and perform version checks on available API versions. The system 200 (e.g., via init-container A 214) may detect incompatible versions between services within the system and identify a need and/or opportunity to change one or more versions to improve interdependent service compatibility. Init-container A 214 may aggregate any necessary API versions, perform one or more versions checks on available API versions, and request a microservice (e.g., a pod) update if such an update is necessary or will facilitate system compatibility and/or workload execution. In some embodiments of the present disclosure, init-container A 214 may identify an incompatible version and/or request a version change for a microservice (e.g., a pod). Init-container A 214 may request a microservice version change from the deployment manager 240.

The system 200 may receive a request to process a workload; the system 210 may task service A 210 with assigning the workload to the proper resources. Service A 210 may contact service C 230 to determine whether service C 230 has the resources to execute the workload. Service C 230 may have an API 232 and an init-container C 234. Service A 210 may contact service C 230 by communicating with the API 232 for service C 230.

Service A 200 may determine that service C 230 is capable of executing a requested workload but requires a version change to execute the workload. Init-container A 214 may thus communicate to the deployment manager 240 that a microservice (e.g., service C 230) requires an alternative version (e.g., an upgrade or a downgrade) to execute a workload.

The deployment manager 240 may process the request for the version change. The deployment manager 240 may implement a version change upon the determination that automatic updates are enabled or upon user approval. The deployment manager 240 may communicate with the selected service in the system to deploy an updated version. As the system 200 identified service C 230 as the host for the requested workload, the deployment manager 240 may communicate with service C 230 to deploy the updated version. The updated version may be, for example, the requested version or an alternative version identified as capable of executing the requested workload. The updated version may be, for example, an upgrade (e.g., a newer version) or a downgrade (e.g., an older version).

The system 200 also includes a repository 250. The repository 250 contains library A 260, library B 270, and library C 280. A library in a repository 250 may store one or more versions of a program; stored versions may be previous versions, versions currently in use, and/or versions not yet implemented. Each library in the repository 250 may include images that may be accessed by the system 200 (e.g., via the deployment manager 240) to retrieve and implement one or more versions of a service. Library A 260 includes image A version 1 262, image A version 2 264, and image A version 3 266. Library B 270 includes image B version 1 272, image B version 2 274, and image B version 3 276. Library C 280 includes image C version 1 282, image C version 2 284, and image C version 3 286.

In some embodiments of the present disclosure, the deployment manager 240 may implement a version change when notified by service A 210 to update service C 230. The deployment manager 240 may communicate with the repository 250 to retrieve the appropriate version (e.g., request image B version 2 274) and deploy the requested version of service C 230 in the cluster.

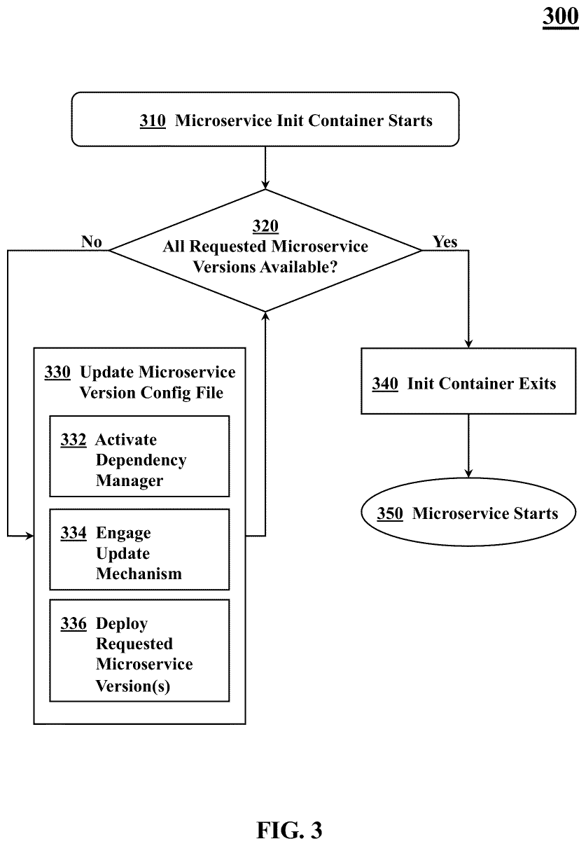

FIG. 3 illustrates a flowchart 300 for resolving microservice incompatibility in accordance with some embodiments of the present disclosure. The flowchart 300 commences with the microservice init container (e.g., init-container A 214 of service A 210 of FIG. 2) starting 310 in a system (e.g., system 200 of FIG. 2). The microservice init container may determine 320 whether all of the requested microservice versions are available. If all of the requested microservice versions are available, the “Yes” branch may be taken, the init container exits 340, and the microservice starts 350.

If any of the requested microservice versions are not available, the “No” branch may be taken. A microservice version config file may be updated 330. This may include activating 332 a dependency manager, engaging 334 an update mechanism, and deploying 336 one or more requested microservice versions. The impacted system (e.g., system 100 of FIG. 1) may then determine 320 (e.g., verify and/or otherwise assess) whether all of the requested microservice versions are available; this loop may occur and recur until all requested microservice versions are available. When all of the requested microservice versions are available, the “Yes” branch may be taken, the init container exits 340, and the microservice starts 350.

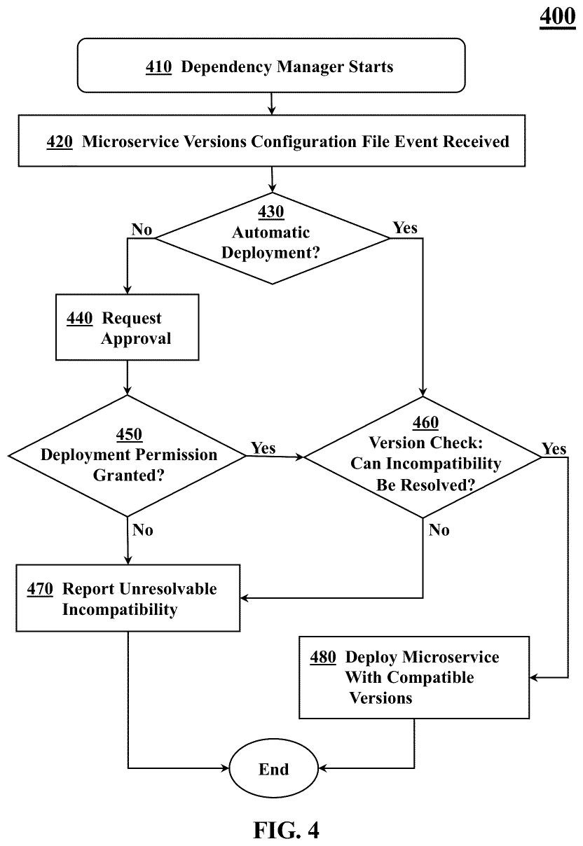

FIG. 4 depicts a flowchart 400 for resolving microservice incompatibility in accordance with some embodiments of the present disclosure. The flowchart 400 commences with the dependency manager (e.g., the deployment manager 140 of FIG. 1) starting 410 within a system (e.g., system 100 of FIG. 1).

The dependency manager may receive 420 a microservice versions configuration file event. A versions configuration file event may be, for example, a request for an alternative version of a program (e.g., a version change for an upgrade or a downgrade). The deployment manager may determine 430 whether or not automatic deployment (e.g., of a different version) is enabled. If automatic deployment is enabled, the dependency manager may perform 460 a version check to identify whether or not an incompatibility (e.g., an incompatibility identified by the microservice versions configuration file event received 420 by the dependency manager) can be resolved. If the incompatibility can be resolved, the system (e.g., via the dependency manager) may deploy 480 the microservice with the compatible versions. For example, a program within an existing microservice may be updated, and the workload may be executed by that service. In another example, the system may deploy a new microservice within the system with the requested version of the requested program to execute the workload.

The deployment manager may receive 420 a microservice versions configuration file event and determine 430 that automatic deployment (e.g., of a version change) is not enabled. The dependency manager may request 440 approval for the deployment (e.g., a version change and/or deployment of a new microservice with the requested version). The dependency manager may request approval from a user (e.g., the user 150 of FIG. 1) such as an administrator or operator. The deployment manager may then assess 450 whether the deployment permission was granted. If permission for deployment was granted, then the dependency manager may perform 460 a version check to identify whether or not an incompatibility can be resolved. If the incompatibility can be resolved, the system may deploy 480 the microservice with the compatible versions. If permission for deployment is not granted, or if an incompatibility cannot be resolved, the system (e.g., via the deployment manager) may report 470 an unresolvable incompatibility (e.g., that a required version is unavailable and a workload may not be executed as a result). The system may report 470 the unresolvable incompatibility to one or more users including, for example, an administrator and the entity requesting the workload.

A computer-implemented method for rectifying incompatibility of microservices in accordance with the present disclosure may include determining an application programming interface (API) version dependency between a first microservice and a second microservice; the first microservice and the second microservice are in a set of dependent microservices. The method may include detecting an incompatible API version in the set of dependent microservices, automatically requesting a version change for the incompatible programming interface version, and implementing the version change.

In some embodiments, the version change may be selected from the group consisting of an upgrade or a downgrade. An upgrade may be considered changing to a newer version (e.g., a more recent version which may or may not be the most current version); for example, it may be an upgrade to change from version 1.113 to version 1.114. A downgrade may be considered changing to an older version (e.g., a less recent version than the microservice is currently using); for example, it may be a downgrade to change from version 1.113 to version 1.112.

In some embodiments, the method may include deploying an updated microservice in the set of dependent microservices. In some circumstances, an update to a program may interfere with current workloads, and deploying a new microservice may enable current workload completion; for example, a pod may be executing a workload requiring a previous version of a program (e.g., version 1.112), a new task may require the most updated version of the same program (e.g., version 1.115), and deploying the updated microservice may enable the cluster to complete the current task while also providing for the new task. In some circumstances, a system may identify a likelihood of needing the non-updated microservice after a newly requested workload; for example, a user may decide to test executing a workload with a new version (e.g., run a beta test) of a program to identify problems to address before releasing the new version, and the system may deploy a separate pod for executing the workload while executing other tasks with the same program in other pods.

In some embodiments, a version change may be implemented automatically. Implementing updates automatically may alleviate user time constraints (e.g., the workload will not need to wait until the update is manually approved for the microservice to execute it). Automatic implementation may work best in environments where the source of the version to be implemented are trusted (e.g., an intranet repository), there is a history of regular updates for the program, and/or the change in the version is within predetermined parameters.

In some embodiments, the version change may be implemented upon approval of an administrator. Requiring administrator approval for a version change engages more manual control and permits for more checks over the system; additional control may be preferred in certain environments (e.g., clusters with sensitive workloads and/or information), for certain programs (e.g., for programs with a history of glitch-ridden updates), for training personnel (e.g., an experienced administrator showing a new administrator an approval process), for other training purposes (e.g., a supervised learning approach of a machine learning algorithm), and the like. Administrator approval of a version change may be preferred in situations where a version to be changed to would not be retrieved from a trusted source, it is unusual for the program to require updates, the version change is outside of defined version change parameters, the version change request prompts a flag from the system, or the like.

In some embodiments, the method may include delaying a microservice deployment until the version change is complete. Delaying microservice deployment may enable the system to avoid version incompatibility issues, scheduling conflicts, or other potential concerns. In some embodiments, delaying the microservice deployment may be responsive to an incompatible API version in the set of dependent microservices. In some embodiments, delaying the microservice deployment may be, or result in, preventing the microservice deployment.

In some embodiments, the method may include reporting the incompatible API version to a user. Reporting the incompatibility to the user may enable the user to respond to the incompatibility concern. For example, the user may identify that the incompatibility is likely to impact other interdependent microservice systems and may proactively prepare the other systems for an impending required version change. In some circumstances, the user may respond by determining a preferred mechanism for handling the incompatibility (e.g., enabling an automatic version change for the issue and/or an automatic change back to the previous version after the completion of the workload). In some embodiments, reporting the incompatible API version to the user may be responsive to the requested microservice version update for the incompatible API version being unavailable; for example, a requested microservice version may not be in any available library or repository as it may have been previously deleted or not yet obtained. In some embodiments, the user may be a system administrator.

In some embodiments, the method may include retrieving a version for the version change from a repository. The version may be, for example, stored as an image in a library in the repository. A repository may store one or more versions; in some embodiments, a repository may store many microservice API versions. The version retrieved may be any of the versions stored; for example, one workload may result in a request to upgrade a microservice API version from 1.113 to 1.115, and a later workload may result in a request to downgrade the microservice API version from 1.115 to 1.111. In some embodiments, any version stored in the repository may be retrieved, regardless as to whether the request is for an upgraded version or a downgraded version. Some repositories may undergo pruning such that some images may no longer be available in the repository; in some circumstances, the pruned images may no longer be available for retrieval, or the images may be available for retrieval via an external source (e.g., via the internet, intranet, or some other a connection to another repository).

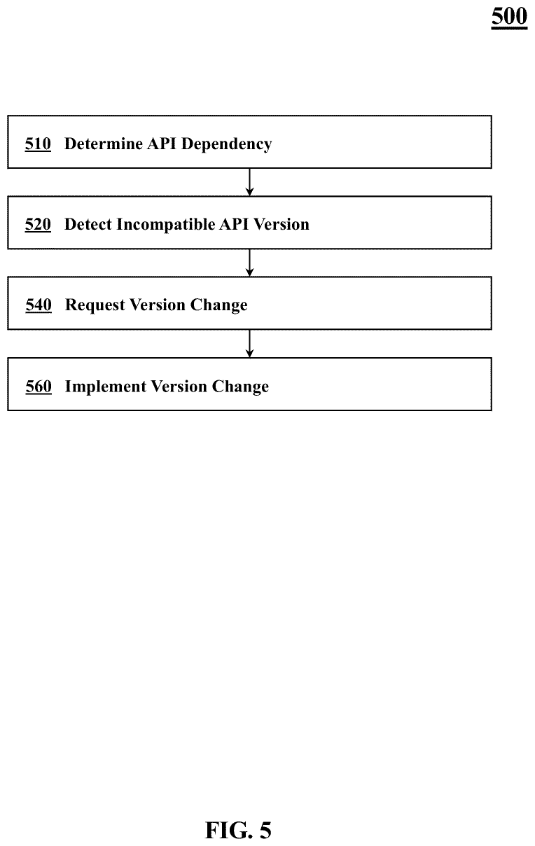

FIG. 5 illustrates a computer-implemented method 500 for resolving microservice incompatibility in accordance with some embodiments of the present disclosure. The method 500 includes determining 510 an API dependency, detecting 520 incompatible API versions, requesting 540 a version change, and implementing 560 the version change.

The method 500 includes determining 510 an application programming interface (API) version dependency between a first microservice and a second microservice. The first microservice and the second microservice may be in a set of dependent microservices. The method 500 includes detecting 520 an incompatible API version in the set of dependent microservices. The method 500 includes requesting 540 a version change for the incompatible API version; in some embodiments, a system may automatically request the version change. The method 500 includes implementing 560 the version change; in some embodiments, a system may automatically implement the version change.

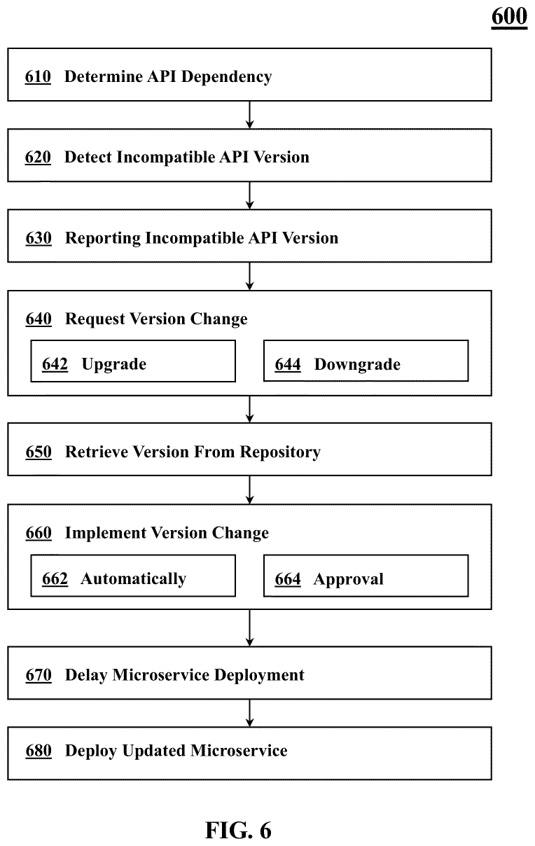

FIG. 6 depicts a computer-implemented method 600 for resolving microservice incompatibility in accordance with some embodiments of the present disclosure.

The method 600 includes determining 610 an application programming interface (API) version dependency between a first microservice and a second microservice. The first microservice and the second microservice may be in a set of dependent microservices. The method 600 includes detecting 620 an incompatible API version in the set of dependent microservices. The method 600 includes reporting 630 an incompatible API version; the incompatibility may be reported to a user (e.g., user 150 of FIG. 1) such as an administrator.

The method 600 includes requesting 640 a version change for the incompatible API version; in some embodiments, a system may automatically request the version change. The version change requested may be an upgrade 642 or a downgrade 644.

The method 600 includes retrieving 650 a version for the version change from a repository (e.g., repository 250 of FIG. 2).

The method 600 includes implementing 660 the version change. The version change may be implemented automatically 662 if automatic version changes are enabled. In some embodiments, the version change may be implemented upon approval 664 of an administrator.

The method 600 includes delaying 670 a microservice deployment until said version change is complete. The method 600 includes deploying 680 an updated microservice in said set of dependent microservices.

A computer program product in accordance with the present disclosure may include a computer readable storage medium having program instructions embodied therewith. The program instructions may be executable by a processor to cause the processor to perform a function. The function may include determining an application programming interface (API) version dependency between a first microservice and a second microservice; the first microservice and the second microservice are in a set of dependent microservices. The function may include detecting an incompatible API version in the set of dependent microservices, automatically requesting a version change for the incompatible programming interface version, and implementing the version change.

In some embodiments, the version change may be selected from the group consisting of an upgrade or a downgrade. An upgrade may be considered changing to a newer version (e.g., a more recent version which may or may not be the most current version); for example, it may be an upgrade to change from version 1.113 to version 1.114. A downgrade may be considered changing to an older version (e.g., a less recent version than the microservice is currently using); for example, it may be a downgrade to change from version 1.113 to version 1.112.

In some embodiments, the function may include deploying an updated microservice in the set of dependent microservices. In some circumstances, an update to a program may interfere with current workloads, and deploying a new microservice may enable current workload completion; for example, a pod may be executing a workload requiring a previous version of a program (e.g., version 1.112), a new task may require the most updated version of the same program (e.g., version 1.115), and deploying the updated microservice may enable the cluster to complete the current task while also providing for the new task. In some circumstances, a system may identify a likelihood of needing the non-updated microservice after a newly requested workload; for example, a user may test executing a workload with a new version (e.g., run a beta test) of a program to identify any problems which may need to be addressed before releasing the new version, and the system may deploy a separate pod for executing the workload while executing other tasks with the same program in other pods.

In some embodiments, the version change may be implemented automatically. Implementing updates automatically may alleviate time constraints (e.g., the workload will not need to wait until the update is manually approved for the microservice to execute it). Automatic implementation may work best in environments where the source of the version to be implemented are trusted (e.g., an intranet repository), there is a history of regular updates for the program, and/or the change in the version is within predetermined parameters.

In some embodiments, the version change may be implemented upon approval of an administrator. Requiring administrator approval for a version change engages more manual control and permits for more checks over the system; additional control may be preferred in certain environments (e.g., clusters with sensitive workloads and/or information), for certain programs (e.g., for programs with a history of glitch-ridden updates), for training personnel (e.g., an experienced administrator showing a new administrator an approval process), for other training purposes (e.g., a supervised learning approach of a machine learning algorithm), and the like. Administrator approval of a version change may be preferred in situations where a version to be changed to would not be retrieved from a trusted source, it is unusual for the program to require updates, the version change is outside of defined version change parameters, the version change request prompts a flag from the system, or the like.

In some embodiments, the function may include delaying a microservice from starting until the version change is complete. Delaying microservice starting may enable the system to avoid version incompatibility issues, scheduling conflicts, and/or other potential concerns. In some embodiments, delaying the microservice starting may be responsive to the incompatible API version in the set of dependent microservices.

In some embodiments, the function may include reporting the incompatible API version to a user. Reporting the incompatibility to the user may enable the user to respond to the incompatibility concern. For example, a user may identify that an incompatibility is likely to impact other interdependent microservice systems and may proactively prepare the other systems for an expected version change requirement. In some circumstances, the user may respond by determining a preferred mechanism for handling the incompatibility (e.g., enabling an automatic version change for the issue and/or an automatic change back to the previous version after the completion of the workload). In some embodiments, reporting the incompatible API version to the user may be responsive to the requested microservice version update for the incompatible API version being unavailable; for example, a requested microservice version may not be in any available library or repository as it may have been previously deleted or not yet obtained. In some embodiments, the user may be a system administrator.

In some embodiments, the function may include retrieving a version for the version change from a repository. The version may be, for example, stored as an image in a library in the repository. A repository may store one or more versions; a repository may store many microservice API versions. The version retrieved may be any of the stored versions; for example, one workload may result in a request to upgrade a microservice API from version 1.113 to version 1.115, and a later workload may result in a request to downgrade the microservice API from version 1.115 to version 1.111. In some embodiments, any version stored in the repository may be retrieved, regardless as to whether the request is for an upgraded version or a downgraded version. Some repositories may undergo pruning such that some images may no longer be available in the repository; in some circumstances, the pruned images may no longer be available for retrieval, or the images may be available for retrieval via an external source (e.g., via the internet, intranet, or some other a connection to another repository).

It is noted that various aspects of the present disclosure may be described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices.

The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination thereof. A computer-readable storage medium should not be construed as storage in the form of one or more transitory signals per se such as radio waves, other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation, or garbage collection, but this does not render the storage device transitory because the data is not transitory while it is stored.

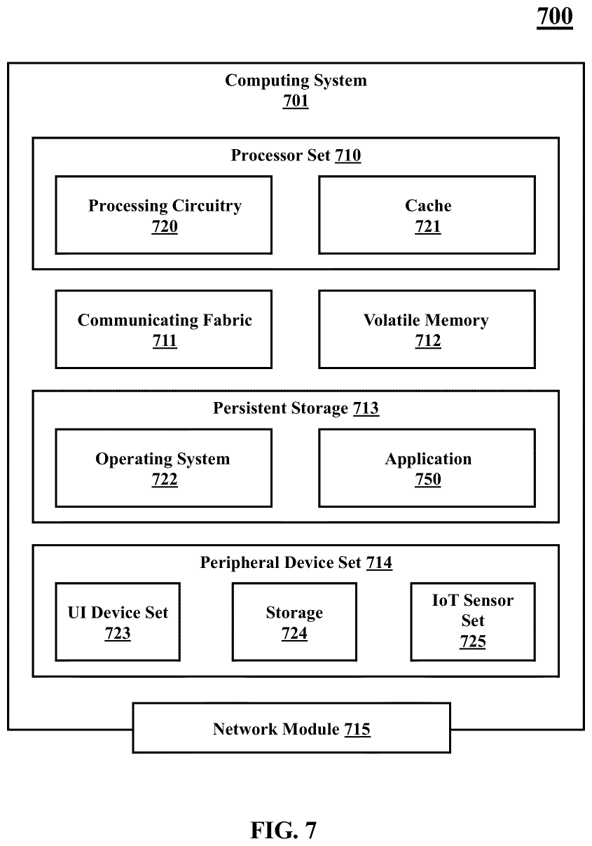

Referring now to FIG. 7, illustrated is a block diagram describing an embodiment of a computing system 701 within in a computing environment 700. The computing environment 700 may be a simplified example of a computing device (e.g., a physical bare metal system and/or a virtual system) capable of performing the computing operations described herein. Computing system 701 may be representative of the one or more computing systems or devices implemented in accordance with the embodiments of the present disclosure and further described below in detail. It should be appreciated that FIG. 7 provides only an illustration of one implementation of a computing system 701 and does not imply any limitations regarding the environments in which different embodiments may be implemented. In general, the components illustrated in FIG. 7 may be representative of an electronic device, either physical or virtualized, capable of executing machine-readable program instructions.

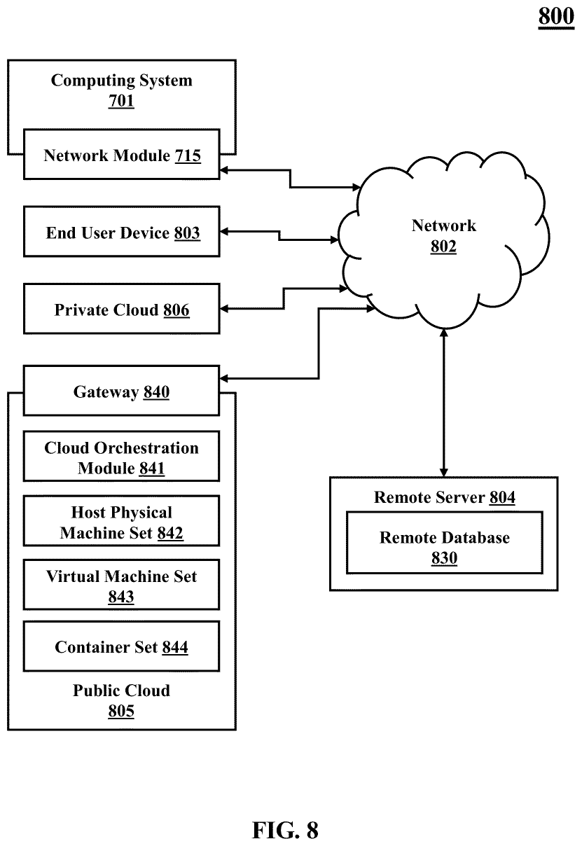

Embodiments of computing system 701 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running an application 750, accessing a network (e.g., network 802 of FIG. 8), or querying a database (e.g., remote database 830 of FIG. 8). Performance of a computer-implemented method executed by a computing system 701 may be distributed among multiple computers and/or between multiple locations. Computing system 701 may be located as part of a cloud network, even though it is not shown within a cloud in FIG. 7 or FIG. 8. Moreover, computing system 701 is not required to be in a cloud network except to any extent as may be affirmatively indicated.

The processor set 710 includes one or more computer processors of any type now known or to be developed in the future. Processing circuitry 720 may be distributed over multiple packages such as, for example, multiple coordinated integrated circuit chips. Processing circuitry 720 may implement multiple processor threads and/or multiple processor cores. The cache 721 may refer to memory that is located on the processor chip package(s) and/or may be used for data and/or code that can be made available for rapid access by the threads or cores running on the processor set 710. Cache 721 memories can be organized into multiple levels depending upon relative proximity to the processing circuitry 720. Alternatively, some or all of the cache 721 may be located “off chip.” In some computing environments, the processor set 710 may be designed for working with qubits and performing quantum computing.

Computer readable program instructions can be loaded onto the computing system 701 to cause a series of operational steps to be performed by the processor set 710 of the computing system 701 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 721 and the other storage media discussed herein. The program instructions, and associated data, can be accessed by the processor set 710 to control and direct performance of the inventive methods. In the computing environments of FIG. 7 and FIG. 8, at least some of the instructions for performing the inventive methods may be stored in persistent storage 713, volatile memory 712, and/or cache 721 as application(s) 750 comprising one or more running processes, services, programs, and installed components thereof. For example, program instructions, processes, services and installed components thereof may include the components and/or sub-components of the system 100 as shown in FIG. 1 and/or system 200 as shown in FIG. 2. For example, program instructions, processes, and/or services may include elements and/or sub-elements of the flowchart 300 as shown in FIG. 3, the flowchart 400 as shown in FIG. 4, the computer-implemented method 500 of FIG. 5, and/or the computer-implemented method 600 as shown in FIG. 6.

The communication fabric 711 may refer to signal conduction paths that may allow the various components of the computing system 701 to communicate with each other. For example, communications fabric 711 may provide for electronic communication among the processor set 710, volatile memory 712, persistent storage 713, peripheral device set 714, and/or network module 715. The communication fabric 711 may be made of switches and/or electrically conductive paths, such as the switches and electrically conductive paths that make up busses, bridges, physical input/output ports, and the like. Other types of signal communication paths may be used such as fiber optic communication paths and/or wireless communication paths.

The volatile memory 712 may refer to any type of volatile memory now known or to be developed in the future. The volatile memory 712 may be characterized by random access; random access is not required unless affirmatively indicated. Examples include dynamic-type random access memory (RAM) or static-type RAM. In the computing system 701, the volatile memory 712 is located in a single package and can be internal to computing system 701; in some embodiments, either alternatively or additionally, the volatile memory 712 may be distributed over multiple packages and/or located externally with respect to the computing system 701. The application 750, along with any program(s), processes, services, and installed components thereof, described herein, may be stored in volatile memory 712 and/or persistent storage 713 for execution and/or access by one or more of the respective processor sets 710 of the computing system 701.

Persistent storage 713 may be any form of non-volatile storage for computers that may be currently known or developed in the future. The non-volatility of this storage means that the stored data may be maintained regardless of whether power is being supplied to the computing system 701 and/or directly to persistent storage 713. Persistent storage 713 may be a read-only memory (ROM); at least a portion of the persistent storage 713 may allow writing of data, deletion of data, and/or re-writing of data. Some forms of persistent storage 713 may include magnetic disks, solid-state storage devices, hard drives, flash-based memory, erasable read-only memories (EPROM), and semi-conductor storage devices. An operating system 722 may take several forms, such as various known proprietary operating systems or open-source portable operating system interface-type operating systems that employ a kernel.

The peripheral device set 714 may include one or more peripheral devices connected to computing system 701, for example, via an input/output (I/O) interface. Data communication connections between the peripheral devices and the other components of computing system 701 may be implemented using various methods. For example, data communication connections may be made using short-range wireless technology (e.g., a Bluetooth® connection), Near-Field Communication (NFC), wired connections or cables (e.g., universal serial bus (USB) cables), insertion-type connections (e.g., a secure digital (SD) card), connections made though local area communication networks, and/or wide area networks (e.g., the internet).

In various embodiments, the UI device set 723 may include components such as a display screen, speaker, microphone, wearable devices (e.g., goggles, headsets, and smart watches), keyboard, mouse, printer, touchpad, game controllers, and/or haptic feedback devices.

The storage 724 may include external storage (e.g., an external hard drive) or insertable storage (e.g., an SD card). The storage 724 may be persistent and/or volatile. In some embodiments, the storage 724 may take the form of a quantum computing storage device for storing data in the form of qubits.

In some embodiments, networks of computing systems 701 may utilize clustered computing and components acting as a single pool of seamless resources when accessed through a network by one or more computing systems 701. For example, networks of computing systems 701 may utilize a storage area network (SAN) that is shared by multiple, geographically distributed computer systems 701 or network-attached storage (NAS) applications.

An IoT sensor set 725 may be made up of sensors that can be used in Internet-of-Things applications. A sensor may be a temperature sensor, motion sensor, infrared sensor, or any other type of known sensor type. One or more sensors may be communicably connected and/or used as the IoT sensor set 725 in whole or in part.

The network module 715 may include a collection of computer software, hardware, and/or firmware that allows the computing system 701 to communicate with other computer systems through a network 702 such as a LAN or WAN. The network module 715 may include hardware (e.g., modems or wireless signal transceivers), software (e.g., for packetizing and/or de-packetizing data for communication network transmission), and/or web browser software (e.g., for communicating data over the network).

In some embodiments, network control functions and network forwarding functions of the network module 715 may be performed on the same physical hardware device. In some embodiments, the control functions and the forwarding functions of network module 715 may be performed on physically separate devices such that the control functions manage several different network hardware devices; for example, embodiments that utilize software-defined networking (SDN) may perform control functions and forwarding functions of the network module 715 on physically separate devices. Computer readable program instructions for performing the inventive methods may be downloaded to the computing system 701 from an external computer or external storage device through a network adapter card and/or network interface included in the network module 715.

Continuing, FIG. 8 depicts a computing environment 800 operating as part of a network. The computing environment 800 of FIG. 8 may be an extension of the computing environment 700 of FIG. 7. In addition to computing system 701, computing environment 800 may include a network 802 (e.g., a WAN or other type of computer network) connecting the computing system 701 to an end user device (EUD) 803, remote server 804, public cloud 805, and/or private cloud 806.

In this embodiment, computing system 701 includes processor set 710 (including the processing circuitry 720 and the cache 721), the communication fabric 711, the volatile memory 712, the persistent storage 713 (including the operating system 722 and the program(s) 750, as identified above), the peripheral device set 714 (including the user interface (UI), the device set 723, the storage 724, and the Internet of Things (IoT) sensor set 725), and the network module 715 of FIG. 7.

In this embodiment, the remote server 804 includes the remote database 830. In this embodiment, the public cloud 805 includes gateway 840, cloud orchestration module 841, host physical machine set 842, virtual machine set 843, and/or container set 844.

The network 802 may be comprised of wired and/or wireless connections. For example, connections may be comprised of computer hardware such as copper transmission cables, optical transmission fibers, wireless transmission, routers, firewalls, switches, gateway computers, and/or edge servers. The network 802 may be described as a WAN (e.g., the internet) capable of communicating computer data over non-local distances by any technology for communicating computer data; the network 802 may make use of technology now known or to be developed in the future. In some embodiments, the WAN may be replaced and/or supplemented by LANs designed to communicate data between devices located in a local area (e.g., a wireless network). Other types of networks that can be used to interconnect the one or more computer systems 701, EUDs 803, remote servers 804, private cloud 806, and/or public cloud 805 may include a Wireless Local Area Network (WLAN), home area network (HAN), backbone network (BBN), peer to peer network (P2P), campus network, enterprise network, the Internet, single- or multi-tenant cloud computing networks, the Public Switched Telephone Network (PSTN), and any other network or network topology known by a person skilled in the art to interconnect computing systems 701.

The EUD 803 may include any computer device that can be used and/or controlled by an end user; for example, a customer of an enterprise that operates computing system 701. The EUD 803 may take any of the forms discussed above in connection with computing system 701. The EUD 803 may receive helpful and/or useful data from the operations of the computing system 701. For example, in a hypothetical case where the computing system 701 provides a recommendation to an end user, the recommendation may be communicated from the network module 715 of the computing system 701 through a WAN network 802 to the EUD 803; in this example, the EUD 803 may display (or otherwise present) the recommendation to an end user. In some embodiments, the EUD 803 may be a client device, (e.g., a thin client), thick client, mobile computing device (e.g., a smart phone), mainframe computer, desktop computer, and/or the like.

A remote server 804 may be any computing system that serves at least some data and/or functionality to the computing system 701. The remote server 804 may be controlled and used by the same entity that operates computing system 701. The remote server 804 represents the one or more machines that collect and store helpful and/or useful data for use by other computers (e.g., computing system 701). For example, in a hypothetical case where the computing system 701 is designed and programmed to provide a recommendation based on historical data, the historical data may be provided to the computing system 701 via a remote database 830 of a remote server 804.

Public cloud 805 may be any computing systems available for use by multiple entities that provide on-demand availability of computer system resources and/or other computer capabilities including data storage (e.g., cloud storage) and computing power without direct active management by the user. The direct and active management of the computing resources of the public cloud 805 may be performed by the computer hardware and/or software of a cloud orchestration module 841. The public cloud 805 may communicate through the network 802 via a gateway 840; the gateway 840 may be a collection of computer software, hardware, and/or firmware that allows the public cloud 805 to communicate through the network 802.

The computing resources provided by the public cloud 805 may be implemented by a virtual computing environment (VCE) or multiple VCEs that may run on one or more computers making up a host physical machine set 842 and/or the universe of physical computers in and/or available to public cloud 705. A VCE may take the form of a virtual machine (VM) from the virtual machine set 843 and/or containers from the container set 844.

VCEs may be stored as images. One or more VCEs may be stored as one or more images and/or may be transferred among and/or between one or more various physical machine hosts either as images and/or after instantiation of the VCE. A new active instance of the VCE may be instantiated from the image. Two types of VCEs may include VMs and containers. A container is a VCE that uses operating system-level virtualization in which the kernel may allow the existence of multiple isolated user-space instances called containers. These isolated user-space instances may behave as physical computers from the point of view of the programs 750 running in them. An application 750 running on an operating system 722 may utilize all resources of that computer such as connected devices, files, folders, network shares, CPU power, and quantifiable hardware capabilities. The applications 750 running inside a container of the container set 744 may only use the contents of the container and devices assigned to the container; this feature may be referred to as containerization. The cloud orchestration module 841 may manage the transfer and storage of images, deploy new instantiations of one or more VCEs, and manage active instantiations of VCE deployments.

Private cloud 806 may be similar to public cloud 805 except that the computing resources may only be available for use by a single enterprise. While the private cloud 806 is depicted as being in communication with the network 802 (e.g., the Internet), in other embodiments, a private cloud 706 may be disconnected from the internet entirely and only accessible through a local/private network.

In some embodiments, a hybrid cloud may be used; a hybrid cloud may refer to a composition of multiple clouds of different types (e.g., private, community, and/or public cloud types). In a hybrid cloud system, the plurality of clouds may be implemented or operated by different vendors. Each of the multiple clouds remains a separate and discrete entity; the larger hybrid cloud architecture is bound together by standardized or proprietary technology that enables orchestration, management, and/or data/application portability between the multiple constituent clouds. In this embodiment, the public cloud 805 and the private cloud 806 may be both part of a larger hybrid cloud environment.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
determining an application programming interface version dependency between a first microservice and a second microservice, wherein said first microservice and said second microservice are in a set of dependent microservices;
detecting an incompatible application programming interface version in said set of dependent microservices;
requesting, automatically, a version change for said incompatible application programming interface version; and
implementing said version change.

2. The system of claim 1, wherein said version change is selected from the group consisting of an upgrade or a downgrade.

3. The system of claim 1, further comprising:
deploying an updated microservice in said set of dependent microservices.

4. The system of claim 1, wherein said version change is implemented automatically.

5. The system of claim 1, wherein said version change is implemented upon approval of an administrator.

6. The system of claim 1, further comprising:
delaying a microservice starting until said version change is complete.

7. The system of claim 1, further comprising:
reporting said incompatible application programming interface version to a user.

8. A computer-implemented method for automatic healing of incompatibility of microservices, said method comprising:
determining an application programming interface version dependency between a first microservice and a second microservice, wherein said first microservice and said second microservice are in a set of dependent microservices;
detecting an incompatible application programming interface version in said set of dependent microservices;
requesting, automatically, a version change for said incompatible application programming interface version; and
implementing said version change.

9. The method of claim 8, wherein said version change is selected from the group consisting of an upgrade or a downgrade.

10. The method of claim 8, further comprising:
deploying an updated microservice in said set of dependent microservices.

11. The method of claim 8, wherein said version change is implemented automatically.

12. The method of claim 8, wherein said version change is implemented upon approval of an administrator.

13. The method of claim 8, further comprising:
delaying a microservice starting until said version change is complete.

14. The method of claim 8, further comprising:
reporting said incompatible application programming interface version to a user.

15. The method of claim 8, further comprising:
retrieving a version for said version change from a repository.

16. A computer program product, said computer program product comprising a computer readable storage medium having program instructions embodied therewith, said program instructions executable by a processor to cause said processor to perform a function, said function comprising:
determining an application programming interface version dependency between a first microservice and a second microservice, wherein said first microservice and said second microservice are in a set of dependent microservices;
detecting an incompatible application programming interface version in said set of dependent microservices;
requesting, automatically, a version change for said incompatible application programming interface version; and
implementing said version change.

17. The computer program product of claim 16, wherein said version change is selected from the group consisting of an upgrade or a downgrade.

18. The computer program product of claim 16, further comprising:
deploying an updated microservice in said set of dependent microservices.

19. The computer program product of claim 16, further comprising:
delaying a microservice starting until said version change is complete.

20. The computer program product of claim 16, further comprising:
reporting said incompatible application programming interface version to a user.
